(19) United States
(12) Patent Application Publication
(10) Pub. No.: US 2025/0371508 A1
(43) Pub. Date: Dec. 4, 2025

(54) METHOD, APPARATUS, AND RECORDING MEDIUM FOR PROVIDING SERVICES RELATED TO NFT THAT REPRESENTS TICKET

(71) Applicants: Hyundai Card Co., Ltd., Seoul (KR); MODERN LION Co., Ltd., Seoul (KR)

(72) Inventor: Du Hee LEE, Seoul (KR)

(21) Appl. No.: 18/956,000

(22) Filed: Nov. 22, 2024

(30) Foreign Application Priority Data
May 31, 2024 (KR) 10-2024-0071761

(51) Int. Cl. G06Q 20/06; G06Q 20/36

(52) U.S. Cl. CPC G06Q 20/065; G06Q 20/363

(57) ABSTRACT

The present disclosure relates to a method, an apparatus, and a recording medium for providing a platform including a trade service of an NFT representing a ticket. The method according to an embodiment of the present disclosure may be performed by at least one processor and include operations of: acquiring a request for generating a first account for an NFT-related service from a terminal of a user, the request for generating the first account indicating another service distinguished from the NFT-related service; acquiring information about a second account corresponding to an account of the user in the another service; generating the first account of the user for the NFT-related service based on the information about the second account; and generating a first digital asset wallet of the user and associating information about the first digital asset wallet with the first account of the user.

### CROSS-REFERENCE TO RELATED APPLICATION

This application is based upon and claims the benefit of priority from Korean Patent Application No. 10-2024-0071761, filed on May 31, 2024, the entire contents of which are incorporated herein by reference.

### TECHNICAL FIELD

The present disclosure relates to a technology for providing a service related to a non-fungible token (NFT) representing a ticket.

### BACKGROUND

A digital asset may be managed in the form of a token issued through a smart contract. Tokens may be classified into fungible tokens and non-fungible tokens (NFTs). Unlike fungible tokens like Bitcoin or Ethereum, each NFT has its own value and may be distinguished from other NFTs. By utilizing the transparency and security of a blockchain, NFTs may make it easier to verify the authenticity of digital assets and prevent counterfeiting or fraudulent trades of digital assets. Further, NFTs may record a trade history on a blockchain in a secondary market, allowing transparent tracking of ownership changes. Accordingly, a technology for applying such NFT technologies to various services has been attracting attention.

### SUMMARY

The present disclosure provides a technology for providing an NFT-related service representing a ticket.

According to an embodiment of the present disclosure, a method performed in an apparatus including at least one processor and a memory configured to store instructions to be executed by the at least one processor may be performed by the at least one processor and include: an operation of acquiring a request for generating a first account for an NFT-related service from a terminal of the user, the request for generating the first account indicating another service distinguished from the NFT-related service; an operation of acquiring information about a second account corresponding to an account of the user in the another service; an operation of generating the first account of the user for the NFT-related service based on the information about the second account; and an operation of generating a first digital asset wallet of the user and associating the information about the first digital asset wallet with the first account of the user.

In an embodiment, the method may further include an operation of transmitting information about at least one of the first account or the first digital asset wallet to the terminal of the user.

In an embodiment, the method may further include an operation of causing information about at least one of the first account or the first digital asset wallet to be displayed on the terminal of the user.

In an embodiment, the method may further include an operation of acquiring a wallet link request from the terminal of the user for associating a second digital asset wallet of the user with the first account and an operation of associating information about the second digital asset wallet with the first account of the user.

In an embodiment, the method may further include an operation of causing the information about the first digital asset wallet not to be associated with the first account in response to associating the information about the second digital asset wallet with the first account.

In an embodiment, the method may further include: an operation of acquiring a request for ticket purchase through a fiat currency from the terminal of the user; an operation of determining approval of payment for a ticket through the fiat currency in response to the ticket purchase request; and an operation of transmitting an NFT representing the ticket to the first digital asset wallet of the user by executing a smart contract corresponding to the ticket through a blockchain network.

In an embodiment, the information about the second account may include information about a payment method of the user for the another service, and the operation of determining approval of payment for the ticket may include an operation of determining approval of the payment for the ticket through the fiat currency based on the information about the second account.

In an embodiment, the method may further include an operation of recording, on a blockchain, information associated with payment for the ticket through the fiat currency through the blockchain network.

In an embodiment, the operation of determining approval of payment for the ticket may include an operation of acquiring information indicating approval of payment for the ticket from an external payment server and an operation of determining approval of payment for the ticket through a fiat currency of the user based on the information indicating approval of payment for the ticket acquired from the external payment server.

In an embodiment, in case that the user corresponds to an owner of an NFT representing the ticket, the method may further include an operation of providing information about the ticket to the terminal of the user.

In an embodiment, the operation of generating the first account may include an operation of determining whether the user already owns an account for the NFT-related service and an operation of generating the first account of the user for the NFT-related service in response to the determination that the user does not already own an account for the NFT-related service.

In an embodiment, the smart contract, in response to the execution of the smart contract, may issue the NFT representing the ticket and transfer the issued NFT to the first digital asset wallet of the user.

In an embodiment, the smart contract, in response to the execution of the smart contract, may transfer the NFT which has been issued before the execution of the smart contract and represents the ticket to the first digital asset wallet of the user.

In an embodiment, the smart contract, based on at least one of a transferor, a transferee, or the NFT representing the ticket, may determine whether the transferor permits transfer of the NFT representing the ticket from a digital asset wallet of the transferor to a digital asset wallet of the transferee and in response to the determination that the transfer is permitted, transfer the NFT representing the ticket from the digital asset wallet of the transferor to the digital asset wallet of the transferee.

According to an embodiment of the present disclosure, an apparatus may include: a communication interface configured to communicate with a terminal of a user; at least one processor; and at least one memory configured to store instructions to be executed by the at least one processor, wherein when the instructions are executed by the at least one processor, the at least one processor is configured to: acquire a request for generating a first account for an NFT-related service from a terminal of the user, the request for generating the first account indicating another service distinguished from the NFT-related service; acquire information about a second account corresponding to an account of the user in the another service; generate the first account of the user for the NFT-related service based on the information about the second account; and generate a first digital asset wallet of the user and associate the information about the first digital asset wallet with the first account of the user.

In an embodiment, the at least one processor may acquire a wallet link request from the terminal of the user for associating a second digital asset wallet of the user with the first account and associate information about the second digital asset wallet with the first account of the user.

In an embodiment, the at least one processor may acquire a request for ticket purchase through a fiat currency from the terminal of the user, determine approval of payment for a ticket through the fiat currency in response to the ticket purchase request, and transmit an NFT representing the ticket to the first digital asset wallet of the user by executing a smart contract corresponding to the ticket through a blockchain network.

In an embodiment, the information about the second account may include information about a payment method of the user for the another service, and wherein the at least one processor may determine approval of payment for the ticket through the fiat currency based on the information of the second account.

In an embodiment, with respect to the smart contract, based on at least one of a transferor, a transferee, or the NFT representing the ticket, it may be determined whether the transferor permits transfer of the NFT representing the ticket from a digital asset wallet of the transferor to a digital asset wallet of the transferee and in response to the determination that the transfer is permitted, the NFT representing the ticket may be transferred from the digital asset wallet of the transferor to the digital asset wallet of the transferee.

A non-transitory computer-readable recording medium according to an embodiment of the present disclosure may correspond to a non-transitory computer-readable recording medium configured to record instructions, when executed by at least one processor, causing the at least one processor to perform an operation, wherein the instructions are configured to cause the at least one processor to perform an operation of acquiring a request for generating a first account for an NFT-related service from a terminal of the user, the request for generating the first account indicating another service distinguished from the NFT-related service; an operation of acquiring information about a second account corresponding to an account of the user in the another service; an operation of generating the first account of the user for the NFT-related service based on the information about the second account; and an operation of generating a first digital asset wallet of the user and associating the information about the first digital asset wallet with the first account of the user.

### BRIEF DESCRIPTION OF DRAWINGS

The accompanying drawings, which are incorporated in and constitute a part of the specification, illustrate embodiments of the present disclosure.

FIG. 1 illustrates an environment to which an apparatus according to an embodiment of the present disclosure is applicable.

FIG. 2 is a block diagram of an apparatus according to an embodiment of the present disclosure.

FIG. 3 is an operational flowchart illustrating a method according to an embodiment of the present disclosure.

FIG. 4 is a sequence diagram illustrating a method according to an embodiment of the present disclosure.

FIG. 5 is a sequence diagram illustrating a method according to an embodiment of the present disclosure.

FIG. 6 is a sequence diagram illustrating a method according to an embodiment of the present disclosure.

FIG. 7 is a sequence diagram illustrating a method according to an embodiment of the present disclosure.

### DETAILED DESCRIPTION

The various embodiments described in the present disclosure are illustrated for the purpose of clarifying the technical ideas of the disclosure and are not intended to limit the disclosure to any particular embodiment. The technical ideas of the present disclosure include various modifications, equivalents, and alternatives of each embodiment of the present disclosure and include embodiments optionally combined from all or part of each embodiment. Furthermore, the scope of the technical ideas of the present disclosure is not limited to the various embodiments set forth below or to the specific description thereof.

Terms used in the present disclosure, including all technical and scientific terms, are intended to have meanings commonly understood by those of ordinary skill in the art to which the present disclosure belongs, unless otherwise defined.

Expressions such as “comprises,” “include,” “may include,” “provided,” “may be provided,” “has,” “may have,” and the like imply the presence of a subject feature (e.g., a function, an operation, or a component) and do not exclude the presence of other additional features. That is, the expressions should be understood as open-ended terms that imply the possibility of including other embodiments.

A singular form used in the present disclosure may include a meaning of a plurality, unless otherwise mentioned, and the same is applied to a singular expression recited in the claims.

Expressions such as “first,” “second,” and the like used in the present disclosure distinguish one object from another in referring to multiple objects of the same type, unless otherwise indicated in the context, and are not intended to limit the order or importance of such objects.

In the present disclosure, expressions such as “A, B, and C,” “A, B, or C,” “A, B, and/or C,” “at least one of A, B, and C,” “at least one of A, B, or C,” “at least one of A, B, and/or C,” “at least one selected from A, B, and C,” “at least one selected from A, B, or C,” and “at least one selected from A, B, and/or C” may each refer to each of the listed items or any possible combination of the listed items. For example, “at least one selected from A and B” may refer to (1) A, (2) at least one of A, (3) B, (4) at least one of B, (5) at least one of A and at least one of B, (6) at least one of A and B, (7) at least one of B and A, or (8) both A and B.

The expression “based on” used in the present disclosure is used to describe one or more factors that influence a determination, an activity of judgment, or an operation described in a phrase or sentence including the relevant expression, and this expression does not exclude an additional factor influencing the determination, the activity of judgment, or the operation.

In the present disclosure, expressions such as a certain component (e.g., a first component) being “connected to” or “coupled with” another component (e.g., a second component) may refer to the certain component being directly connected or coupled to the another component, as well as being connected or coupled through another intervening component (e.g., a third component).

In the present disclosure, the expression “configured to” has meanings such as, depending on the context, “set to,” “having an ability to,” “changed to,” “made to,” “to do,” and “able to.” This expression is not limited to the meaning of “specifically designed in hardware.” For example, “a processor configured to perform a specific operation” may refer to a general purpose processor that may perform the specific operation by executing software, or a special purpose computer that is structured through programming to perform the specific operation.

In the present specification, the term “smart contract” may correspond to a program or application operating on a virtual machine executed by two or more nodes included in a blockchain network. The smart contract may be established to follow certain conventions (or protocols). For example, with reference to ERC-20, ERC-721, ERC-1155, or the like, the smart contract may be established to include at least one function corresponding to each protocol. Inclusion of another function not included in the exemplified protocol may make it possible to establish various types of smart contracts.

The term “blockchain network” used in the present specification may include two or more nodes configured to manage a blockchain. Here, the term “block” may refer to a certain data type. In addition, the blockchain may refer to a data structure in which one or more blocks are connected in a chain form. The one or more blocks included in the blockchain may be independently stored in multiple nodes included in the blockchain network, respectively, or may be distributively stored across multiple nodes. The one or more blocks each may include a block hash value, a block header, or a block body. The block hash value is unique information that identifies the block and may be, for example, a string represented by 256 bits. The block header may include at least one of software or protocol version information, a hash value of a previous block according to a connection order of blocks on the blockchain, a Merkle root, time information indicating a time when the block was generated, bits representing a difficulty of computation, or a nonce corresponding to a value required for a mining operation to add a new block to the blockchain. The block body may include at least one transaction. The transaction may be a set of data having a specific data structure and a unit of information stored in the block body. The transaction may include information on token generation or trade.

At least one node included in the blockchain network may each be referred to as a “participant.” At least one node included in the blockchain network may be operated by a hierarchy structure. The hierarchy structure may include, for example, at least one of a data layer which defines a structure of data handled by the blockchain network and manages the data, a consensus layer which verifies the validity of a block, performs mining for generating a block, and is responsible for processing a fee paid to a miner during a mining process, a common layer which implements or manage a P2P network protocol, a hash function, a digital signature, encoding, and a common storage, or an application layer in which various applications are generated or processed.

At least one node included in the blockchain network may share or store a transaction recorded on the blockchain. Further, at least one node included in the blockchain network may perform verification with respect to a transaction transmitted to the blockchain network through a consensus algorithm of the blockchain and in case that the verification is completed, perform a function for recording the verified transaction on one block of the blockchain. There is no limit to the type of consensus algorithm performed by the blockchain network and all types of consensus algorithms that may be adopted and modified by those skilled in the art may be performed. For example, the consensus algorithm may include at least one of a Proof of Work (PoW) algorithm, a Proof of Stake (PoS) algorithm, a Delegated Proof of Stage (DPoS) algorithm, a Practical Byzantine Fault Tolerance (PBFT) algorithm, a Delegated Byzantine Fault Tolerance (DBFT) algorithm, a Redundant Byzantine Fault Tolerance (RBFT) algorithm, a Sieve algorithm, a Tendermint algorithm, a Paxos algorithm, a Raft algorithm, a Proof of Authority (PoA) algorithm, or a Proof of Elapsed Time (PoET) algorithm, or an application of at least one of the above consensus algorithms.

At least one node included in the blockchain network may store a smart contract. As such, at least one node included in the blockchain network may share an identical smart contract. In addition, the smart contract may be stored in one block on the blockchain managed by the blockchain network. The smart contract may be a specification or script written in a programming language such as Solidity, etc. and may be a program or application that operates on a virtual machine executed by at least one node included in the blockchain network. The smart contract may be established such that a certain operation is executed when a certain condition is satisfied. Here, the certain condition may include, for example, a condition that a certain kind of token is entered or a file of a certain format is entered. The certain operation may include an operation of transmitting a certain type of token to a predetermined node of the blockchain network.

The term “token” used in the present specification may represent a digital asset or a unit of value. The token may be recorded on the blockchain network and may be present in an electronic form. The blockchain-based platform may have an economic model of issuing its own tokens and using the tokens within an ecosystem to pay for services, rewards, discounts, and the like. Such tokens may support and adjust various economic activities within the ecosystem. Furthermore, a blockchain token may be used as a method for verification of a certain asset or ownership. For example, a physical asset, such as real estate or artwork, may be represented by a blockchain token to prove and transfer ownership. The token may include a security token. The security token may represent a digitization of a security (e.g., a stock, a bond, real estate, and the like) under the Capital Markets Act. For example, a token owner may receive a portion of profits generated by a token issuer as a dividend or hold a portion of an issuer's management rights through a security token. A smart contract standard for security tokens may be in a form of an Ethereum request for comments (ERC) standard, which may be adopted by a person skilled in the art, and an interface that may be modified by a person skilled in the art. For example, a smart contract interface of the security token may be ERC 1400, ERC1594, ERC1410,ERC1643, ERC1644, or ERC3643.

In the present specification, the term “digital asset wallet” may be a tool for securely storing and managing an individual's digital asset in an electronic form. The digital asset wallet may store and manage information related to a cryptocurrency or digital asset. The digital asset wallet may be classified into a hot wallet and a cold wallet. The hot wallet is a wallet connected to the Internet and has a form that allows access to cryptocurrency in an online environment. The hot wallet may generally be provided as a software wallet or online service. The hot wallet may provide convenient and fast access to transfer a cryptocurrency, and process trades quickly. The cold wallet may correspond to a wallet configured to store a private key in an offline environment not connected to the Internet. The cold wallet may be provided as a hardware wallet or paper wallet. The cold wallet may safely protect a private key and may be stored in an offline state, thus providing a high level of security against hacking or malicious software attacks.

In the present specification, “transmitting a transaction to a blockchain” may include (1) uploading certain data to a blockchain, (2) modifying or deleting data pre-uploaded on a blockchain, or (3) executing a smart contract distributed to a blockchain.

The term “transaction” used in the present specification is a logical unit of an operation performed on a blockchain. The term “transaction” used in the present specification may include a transaction recorded on a blockchain and/or a transaction not recorded on a blockchain. For example, a transaction on an Ethereum blockchain may include (1) a transaction recorded on a blockchain having a transaction hash value, and (2) a message (internal transaction) generated when the transaction is executed on an Ethereum virtual machine (EVM).

Hereinafter, embodiments described in the present disclosure will be explained with reference to the accompanying drawings. In the accompanying drawings and descriptions of the drawings, identical or substantially equivalent components may be given a same reference numeral. Furthermore, in the description of various embodiments below, duplicate descriptions of identical or corresponding components may be omitted, but this does not mean that the components are not included in the embodiments.

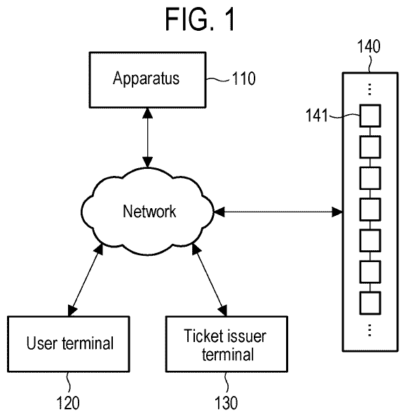

FIG. 1 illustrates an environment to which an apparatus 110 according to an embodiment of the present disclosure is applicable. The corresponding environment may include an apparatus 110, a user terminal 120, a ticket issuer terminal 130, a blockchain network 140, and/or a computer network. The blockchain network 140 may include two or more nodes 141. The apparatus 110, the user terminal 120, the ticket issuer terminal 130, and each node 141 of the blockchain network 140 may communicate with each other through a network. The network is a digital electrical telecommunication network and refers to connecting various distributed apparatuses through a specific communication network. FIG. 1 illustrates an environment in which the apparatus 110 performs communication with two terminals 120 and 130 and seven nodes 141 through a computer network, but this is only an example and the number of terminals and nodes may vary.

The apparatus 110 may correspond to an electronic apparatus configured to provide and manage a platform including an NFT-related service. The NFT-related service may include an NFT trading service allowing online NFT trading. Specifically, the NFT-related service may correspond to a service allowing trading of an NFT representing a ticket. For example, the NFT trading service may include trading between an issuer of an NFT and a primary transferee, trading between a first transferee and a secondary transferee, and trading between subsequent transferees. The platform including the NFT-related service may be a kind of NFT exchange. The ticket may correspond to a token representing a user's right to use a service or enter an event (e.g., an event like a concert). The ticket may include a determined condition and a restriction, which allows the ticket owner to receive the corresponding service or to participate in the event. Furthermore, the NFT-related service may include a service for issuing an NFT representing a ticket. The apparatus 110 may correspond to a server configured to provide a platform including the NFT-related service. The apparatus 110 may generate various pages constituting an application or a website regarding the platform including the NFT-related service and provide the generated pages to the user terminal 120 or the ticket issuer terminal 130 to be displayed on the application or the website.

The user terminal 120 and the ticket issuer terminal 130 may correspond to apparatuses configured to use the NFT-related service. The user terminal 120 and the ticket issuer terminal 130 may be implemented as terminals capable of transmitting or receiving various information to or from the apparatus 110 through the network. For example, the user terminal 120 and the ticket issuer terminal 130 may correspond to one of a computer, a laptop, a portable communication terminal (a smartphone and the like), a portable multimedia apparatus, a wearable apparatus, or a head mounted display (HMD). However, the types of the user terminal 120 and the ticket issuer terminal 130 are not limited thereto and the user terminal 120 and the ticket issuer terminal 130 may include predetermined apparatuses which may receive information from the user or the ticket issuer, include an input/output interface capable of outputting information to the user or the ticket issuer, and perform communication with the apparatus 110 or another apparatus through the network.

The user terminal 120 and the ticket issuer terminal 130 may provide information received from the apparatus 110 to the user or the ticket issuer and receive an input from the user or the ticket issuer so as to transmit the input to the apparatus 110. Specifically, the user terminal 120 and the ticket issuer terminal 130 may acquire various inputs from the user or the ticket issuer and transmit information corresponding to the acquired inputs to the apparatus 110. The inputs acquired from the user or the ticket issuer may include various forms of input, such as clicking using a mouse, touching using a touch pad or touch screen, voice recognition, and other electronic inputs. For example, the inputs from the user or the ticket issuer may include inputs through various UI elements. The user terminal 120 and the ticket issuer terminal 130 may receive an instruction causing various information received from the apparatus 110 to be displayed and output (display) various information based on the received information or instruction.

The network may perform a function for connecting the apparatus 110 and the user terminal 120 and the ticket issuer terminal 130 or other external apparatuses. For example, the network may provide an access path so that the user terminal 120 or the ticket issuer terminal 130 may be connected to the apparatus 110 and transmit or receive packet data to or from the apparatus 110. The network may be implemented as all kinds of wired or wireless network, for example, a local area network (LAN), a wide area network (WAN), a mobile radio communication network, the wireless broadband Internet (Wibro), and the like.

One node 141 included in the blockchain network 140 may represent an apparatus of one participant participating in the blockchain network 140. The node 141 may correspond to an element constituting the blockchain network 140. The node 141 may perform a calculation to maintain the blockchain of the blockchain network 140. For example, a node of the blockchain network 140 may generate a new block of the corresponding blockchain, and the new block may be shared among other nodes in the blockchain network through a process of distributed consensus and linked to a next block in the blockchain. That is, the node 141 may perform an operation of generating, verifying, or propagating a transaction and a block in which the transaction is recorded. The node 141 may correspond to a full node, a light node, a master node, a mining node, a random node, a baking node, or a super node, depending on an operation performed by the node. The node 141 may perform issuing of tokens by interacting with the apparatus 110. Issuing of tokens may indicate a process in which an issuer uses a smart contract to generate a certain amount of tokens and store the generated tokens in an issuer's wallet.

The node 141 may be implemented as a computing apparatus. For example, the aforementioned computing apparatus may include, but is not limited to, a desktop computer, a laptop computer, or the like, and may be any apparatus of various kinds having computing capabilities.

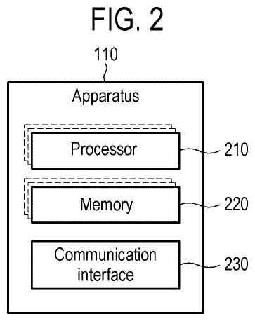

FIG. 2 is a block diagram of an apparatus 110 according to an embodiment of the present disclosure. The apparatus 110 may provide a platform including the NFT-related service. Specifically, the apparatus 110 may process information regarding the NFT-related service. In addition, the apparatus 110 may process information regarding an NFT representing a ticket.

In an embodiment, the apparatus 110 may include at least one processor 210, at least one memory 220, and a communication interface 230 as components. In an embodiment, at least one of the components included in the apparatus 110 may be omitted or another component may be added to the apparatus 110. In an embodiment, additionally or alternatively, some of the components may be integrated and implemented, or implemented as a singular or plural entities.

In the present disclosure, at least one processor 210 may be expressed as a processor 210. The expression “processor” 210 may refer to a set of one or more processors, unless the context clearly indicates otherwise. In the present disclosure, at least one memory 220 may be expressed as a memory 220. The expression “memory” 220 may refer to a set of one or more memories, unless the context clearly indicates otherwise. In an embodiment, at least some of the components in the apparatus 110 may be connected to each other through a bus, a general purpose input/output (GPIO), a serial peripheral interface (SPI), or a mobile industry processor interface (MIPI), and may transmit and receive information (data, a signal, or the like).

The processor 210 may control at least one component of the apparatus 110 connected to the processor 210 by driving software (e.g., an instruction, a program, or the like). In addition, the processor 210 may perform operations, such as various calculations, processing, data generation, manipulation, etc. related to the present disclosure. In addition, the processor 210 may load data or the like from the memory 220 or store the same in the memory 220. In an embodiment, the processor 210 may control the communication interface 230 to transmit various information to the user terminal 120 or the ticket issuer terminal 130 and receive various information from the user terminal 120 or the ticket issuer terminal 130. For example, the processor 210 may control the communication interface 230 to receive a request for generating a first account or a ticket purchase request from the user terminal 120. In addition, the processor 210 may control the communication interface 230 to receive a ticket purchase request from the ticket issuer terminal 130. In addition, the processor 210 may access the memory 220 to acquire various information. The processor 210 may generate various pages regarding the NFT-related service and provide information on the generated pages to the user terminal 120. The processor 210 may generate various pages regarding ticket issuance and provide information on the generated pages to the ticket issuer terminal 130.

The memory 220 may store various information (data). The information stored in the memory 220 may be acquired, processed, or used by at least one component of the apparatus 110 and may include software (e.g., an instruction, a program, or the like). The memory 220 may include a transitory and/or non-transitory memory. In the present disclosure, the instruction or program may correspond to software stored in the memory 220 and may include an operating system for controlling a resource of the apparatus 110, an application, and/or middleware for providing various functions to an application so that the application may use various resources of the apparatus 110. In an embodiment, the memory 220 may store instructions, which when executed by the processor 210 cause the processor 210 to perform calculations. Specifically, the memory 220 may store information on the platform including the NFT-related service and instructions to be executed by the processor 210. Furthermore, the memory 220 may store information on a user's account and/or wallet.

The communication interface 230 may perform wired or wireless communication among the apparatus 110 and the user terminal 120, the ticket issuer terminal 130, a server for another service, an external payment server, a database, or another external apparatus. For example, the communication interface 230 may perform wireless communication using a method, such as enhanced mobile broadband (eMBB), ultra reliable low-latency communications (URLLC), massive machine type communications (MMTC), long-term evolution (LTE), LTE advance (LTE-A), new radio (NR), universal mobile telecommunications system (UMTS), global system for mobile communications (GSM), code division multiple access (CDMA), wideband CDMA (WCDMA), wireless broadband (WiBro), wireless fidelity (Wi-Fi), Bluetooth, near field communication (NFC), global positioning system (GPS), or global navigation satellite system (GNSS). For example, the communication interface 230 may perform wired communication using a method, such as universal serial bus (USB), high-definition multimedia interface (HDMI), recommended standard-232 (RS-232), or plain old telephone service (POTS). In an embodiment, the apparatus 110 may be integrally implemented with another apparatus. In this case, the communication interface 230 may function as an access circuit or interface for connecting the apparatus 110 and another corresponding apparatus.

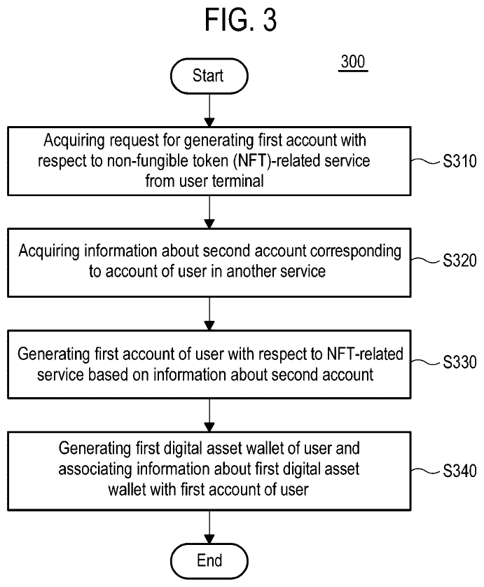

Hereinafter, with respect to FIGS. 3 to 7, an operation described as being performed by the apparatus 110 may be understood as being performed by the processor 210 of the apparatus 110 as shown in FIG. 2. In addition, with respect to FIGS. 3 to 7, among operations described as being performed by the apparatus 110, an operation including communication with the user terminal 120, the ticket issuer terminal 130, or another apparatus may be understood as being performed by the processor 210 of the apparatus 110 by controlling the communication interface 230 as shown in FIG. 2.

FIG. 3 is an operational flowchart illustrating a method 300 according to an embodiment of the present disclosure. The method 300 may include an operation S310 of acquiring a request for generating a first account with respect to an NFT-related service by the apparatus 110 from the user terminal 120, an operation S320 of acquiring information about a second account corresponding to an account of the user in another service, an operation S330 of generating the first account of the user with respect to the NFT-related service based on the information about the second account, and an operation S340 of generating a first digital asset wallet of the user and associating the information about the first digital asset wallet with the first account of the user.

The request for generating the first account acquired from the user terminal 120 may indicate another service distinguished from the NFT-related service. Here, the another service may include, for example, a social network service, an e-mail service, a search engine service, or the like. That is, the request for generating the first account may correspond to a request for generating an account of the NFT-related service based on the user's account for the another service. Such request for generating an account may be referred to as a request for social sign-in, social sign-on, or social login. For example, the request for generating the first account acquired from the user terminal 120 may include information about verification of a second account corresponding to a user's account for another service. For example, the information about the second account may include information about an ID and password corresponding to the second account.

The apparatus 110 may acquire information about the second account based on the information about verification of the second account of the user. The information about the second account may include information on the user required for generating the first account. For example, information such as the user's name, date of birth, contact information, address, etc. may be required for generating the first account for the NFT-related service. Meanwhile, information, such as the user's name, date of birth, contact information, address, etc., corresponding to the second account which has already been generated for another service may be stored in a server for the another service. Accordingly, the apparatus 110 may acquire information, such as the user's name, date of birth, contact information, address, etc., corresponding to the second account of the user for the another service from the server for the another service.

The apparatus 110 may generate the first account of the user for the NFT-related service, by using the information, such as the user's name, date of birth, contact information, address, etc., corresponding to the second account of the user for the another service. That is, the first account of the user with respect to the NFT-related service may be linked to the second account of the user for the another service. After generating the first account based on the second account, the user may log in to the NFT-related service with the first account through the information about verification of the second account for the another service and a log-in request of the first account via the second account. That is, in case of acquiring the information about verification of the second account and the log-in request of the first account through the second account from the user terminal 120, the apparatus 110 may perform log-in processing through the first account of the user with respect to the NFT-related service. Alternatively, in case that the user terminal 120 is logged in through the second account for another service and the log-in request of the first account through the second account is acquired from the user terminal 120, the apparatus 110 may perform log-in processing through the first account of the user for the NFT-related service.

The apparatus 110 may generate a first digital asset wallet of the user for the NFT-related service by using a predetermined digital asset wallet generation algorithm. The digital asset wallet generation algorithm may include a procedure for acquiring an address, a public key, and a private key for a digital asset wallet. For example, the apparatus 110 may link the private key for the first digital asset wallet to the first account of the user and store the private key. Alternatively, the apparatus 110 may provide the private key for the first digital asset wallet to the user and may not separately store the private key.

The apparatus 110 may associate information about the first digital asset wallet with the first account of the user. Specifically, associating information about the first digital asset wallet with the first account of the user may mean generating information indicating that the first digital asset wallet corresponds to the first account of the user. For example, the apparatus 110 may generate information indicating that an address of the first digital asset wallet corresponds to the first account of the user. The apparatus 110 may store the information indicating that the address of the first digital asset wallet corresponds to the first account of the user.

In an embodiment, in case that the user corresponds to an owner of the NFT representing the ticket, the apparatus 110 may provide information about the ticket to the user terminal 120. Specifically, the apparatus 110 may determine whether the user is the owner of the NFT representing the ticket, and in case of determining that the user is the owner of the NFT representing the ticket, provide the information about the ticket to the user terminal 120. The information about the ticket may include information indicating that the user has the right to use a certain service or enter a certain event. For example, the information about the ticket may include the user's identification information (e.g., a user's name), information indicating a certain service or a certain event (e.g., a name, provision time, and provision content of a certain service, or a name, progress time, and content of a certain event, etc.). In an embodiment, the information about the ticket may be provided in a text or image form, or provided in a quick response code (QR) form. In an embodiment, in response to receiving, from the user terminal 120, a request for providing information about the ticket, the apparatus 110 may determine whether the user is the owner of the NFT representing the ticket, and in case of determining that the user is the owner of the NFT representing the ticket, provide the information about the ticket to the user terminal 120.

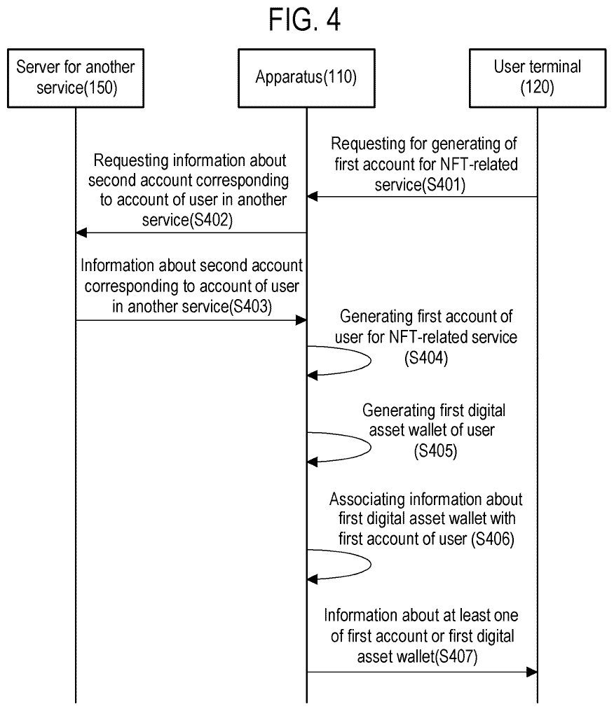

FIG. 4 is a sequence diagram illustrating a method according to an embodiment of the present disclosure. The user terminal 120 may transmit a request for generating the first account for the NFT-related service (S401). The request for generating the first account for the NFT-related service may include information indicating another service and authentication information about the second account of the user in the another service.

The apparatus 110 may transmit, to the server 150 for the another service, an information request for the second account which is an account of the user in the another service (S402). The apparatus 110 may transmit a request for information about the second account for generating the first account together with authentication information about the second account of the user in the another service.

The server 150 for the another service may transmit, to the apparatus 110, information about the second account which is an account of the user in the another service (S403). For example, the server 150 for the another service may perform authentication for the second account based on the authentication information about the second account of the user acquired from the apparatus 110 and, in response to completion of the authentication for the second account, transmit information about the second account to the apparatus 110.

The apparatus 110 may generate the first account of the user for the NFT-related service (S404). In an embodiment, the apparatus 110 may determine whether the user already owns an account for the NFT-related service and generate the first account of the user for the NFT-related service in response to determining that the user does not already own an account for the NFT-related service. In an embodiment, the apparatus 110 may determine whether the user already owns an account for the NFT-related service before S402. For example, the apparatus 110 may determine whether the user already owns an account for the NFT-related service through information stored in the memory 220 or another external storage. Thereafter, in response to determining that the user owns an account for the NFT-related service, the apparatus 110 may not perform S402 to S407.

The apparatus 110 may generate a first digital asset wallet of the user (S405). S404 and S405 may be at least concurrently performed or S405 may be performed before S404. The apparatus 110 may associate information about the first digital asset wallet with the first account of the user (S406). The apparatus 110 may transmit information about at least one of the first account or the first digital asset wallet to the user terminal 120 (S407). In an embodiment, the apparatus 110 may cause information about at least one of the first account or the first digital asset wallet to be displayed on the user terminal 120. Specifically, the apparatus 110 may transmit, to the user terminal 120, information indicating completion of generating the first account, identification information of the first account, information indicating that the first account is associated with the first digital asset wallet, or information indicating at least one of an address, a public key, or a private key of the first digital asset wallet. In addition, the apparatus 110 may transmit, to the user terminal 120, information causing the information above to be displayed on the user terminal 120.

In an embodiment, the apparatus 110 may acquire a wallet link request for associating a second digital asset wallet of the user with the first account from the user terminal 120. The second digital asset wallet may refer to a digital asset wallet which the user already has. For example, the second digital asset wallet may be generated through another service other than the NFT-related service provided by the apparatus 110. In addition, the wallet link request for associating the second digital asset wallet of the user with the first account may include information about the second digital asset wallet of the user. In an embodiment, the apparatus 110 may associate information about the second digital asset wallet with the first account of the user. That is, the apparatus 110 may generate information indicating that an address of the second digital asset wallet corresponds to the first account of the user. In an embodiment, in response to the association of the information about the second digital asset wallet with the first account, the apparatus 110 may cause the information about the second digital asset wallet not to be associated with the first account. Specifically, in response to the association of the information about the second digital asset wallet with the first account, the apparatus 110 may delete information indicating that information about the first digital asset wallet which has already been generated is associated with the first account.

In an embodiment, the apparatus 110 may acquire a wallet link request for associating the second digital asset wallet of the user with the first account together with a request for generating the first account for the NFT-related service. In this case, the apparatus 110 does not need to perform S405 and S406. Accordingly, in case of acquiring the wallet link request for associating the second digital asset wallet with the first account together with the request for generating the first account, the apparatus 110 may omit the operation of generating the first digital asset wallet of the user and the operation of associating the information about the first digital asset wallet with the first account of the user. Instead, the apparatus 110 may perform an operation of associating the second digital asset wallet of the user with the first account. Here, the apparatus 110 may transmit information about at least one of the first account or the second digital asset wallet to the user terminal 120, instead of performing S407.

In another embodiment, the apparatus 110 may determine whether the user already has the second digital asset wallet through information about the second account. In this case, the information about the second account may determine information about whether the user already has the second digital asset wallet. In addition, in case that the user already has the second digital asset wallet, the information about the second account may further include information about the second digital asset wallet. Accordingly, in response to receiving, from the server 150 for another service, information indicating that the user already has the second digital asset wallet, the apparatus 110 may not perform S405, S406, and S407 and instead, associate the information about the second digital asset wallet with the first account, and transmit information about at least one of the first account or the second digital asset wallet, to the user terminal 120.

In another embodiment, the apparatus 110 may acquire, together with the request for generating the first account for the NFT-related service, “a conditional wallet link request for, in case that information about the second digital asset wallet already owned by the user is identified through the information about the second account, associating the corresponding second digital asset wallet with the first account” from the user terminal 120. In this case, in response to receiving, from the server 150 for another service, information indicating that the user already has the second digital asset wallet, the apparatus 110 may not perform S405, S406, and S407 and instead, associate the information about the second digital asset wallet with the first account, and transmit information about at least one of the first account or the second digital asset wallet, to the user terminal 120.

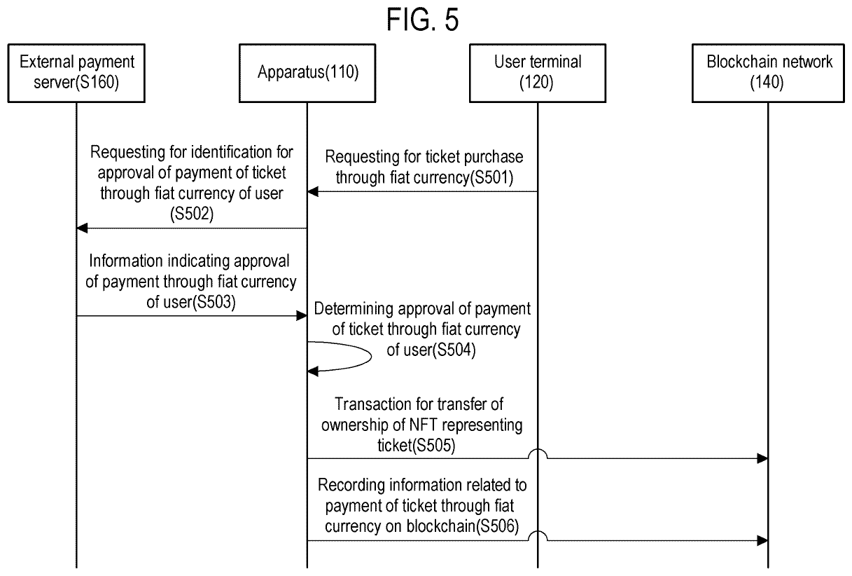

FIG. 5 is a sequence diagram illustrating a method according to an embodiment of the present disclosure. The apparatus 110 may acquire a request for ticket purchase through a fiat currency from the user terminal 120 (S501). In an embodiment, the apparatus 110 may acquire information about a payment method through the fiat currency from the user terminal 120. For example, the request for ticket purchase through the fiat currency may include information about the payment method through the fiat currency. Alternatively, the apparatus 110 may acquire information about a payment method through the fiat currency from the user terminal 120 separately from the request for ticket purchase through the fiat currency. The information about a payment method through the fiat currency may include information about payment through the fiat currency (such as, an account number of an account containing the fiat currency and authentication information about processing payments through the account, or authentication information about processing payments through a credit/debit card). The request for ticket purchase through the fiat currency may correspond to a request for purchasing an NFT representing a ticket minted from a ticket issuer or an NFT representing a ticket transferred to another user from the another user. In both cases, a trade of the NFT representing the ticket may be executed if a selling price and a buying price between a transferor and a transferee match.

The apparatus 110 may determine, in response to the ticket purchase request, approval of payment for the ticket through the fiat currency. In an embodiment, based on information indicating approval of payment for the ticket acquired from an external payment server 160, the apparatus 110 may determine approval of payment for the ticket through the fiat currency of the user. In this case, the apparatus 110 may transmit an identification request for the approval of payment for the ticket to the external payment server 160 (S502). In addition, the apparatus 110 may transmit information about the payment method through the fiat currency to the external payment server 160. Based on the identification request for approval of payment for the ticket and the information about the payment method through the fiat currency acquired from the apparatus 110, the external payment server 160 may perform ticket payment processing through the fiat currency according to a trade execution price and determine approval of payment for the ticket through the fiat currency of the user. Thereafter, the external payment server 160 may transmit information about approval of payment for the ticket through the fiat currency of the user (information indicating that a payment has been approved or disapproved) to the apparatus 110. The apparatus 110 may acquire information indicating approval of payment for the ticket from the external payment server 160 (S503).

The apparatus 110 may determine approval of payment for the ticket through the fiat currency of the user (S504). For example, based on information about approval of payment for the ticket through the fiat currency of the user acquired from an external payment server 160, the apparatus 110 may determine approval of payment for the ticket through the fiat currency of the user.

The apparatus 110 may transmit a transaction for transfer of ownership of the NFT representing the ticket to the blockchain network 140 (S505). That is, the apparatus 110 may execute a smart contract corresponding to the ticket through the blockchain network 140 to transmit the NFT representing the ticket from a transferor's digital asset wallet to a user's digital asset wallet (the first digital asset wallet or the second digital asset wallet). Specifically, in case that the transferor is the ticket issuer, the NFT representing the ticket may be stored in a ticket issuer's digital asset wallet or the apparatus 110, that is, the digital asset wallet of the server. In this case, the apparatus 110 may execute a smart contract for transferring, through the blockchain network 140, the NFT representing the ticket from the transferor's digital asset wallet or the apparatus 110, that is, the digital asset wallet of the server to the user's digital asset wallet (the first digital asset wallet or the second digital asset wallet). Alternatively, in case that the transferor is another user, the apparatus 110 may execute a smart contract for transferring, through the blockchain network 140, the NFT representing the ticket from the another user's digital asset wallet to the user's digital asset wallet (the first digital asset wallet or the second digital asset wallet).

In an embodiment, the smart contract, based on at least one of a transferor, a transferee, or the NFT representing the ticket, may determine whether the transferor permits transfer of the NFT representing the ticket from a digital asset wallet of the transferor to a digital asset wallet of the transferee and in response to determining that the transfer is permitted, transfer the NFT representing the ticket from the digital asset wallet of the transferor to the digital asset wallet of the transferee. For example, the smart contract may identify the NFT owned by the transferor or the transferee. Alternatively, the smart contract may identify a transaction history of the transferor's wallet or the transferee's digital asset wallet. As another example, the smart contract may identify a transaction history of the NFT representing the ticket and calculate an ownership change history. As such, by allowing the smart contract to determine whether the NFT representing the ticket is transferred based on information about at least one of the transferor, the transferee, or the NFT representing the ticket, ticket scalping may be prevented.

The apparatus 110 may record, through the blockchain network 140, information related to payment for the ticket through a fiat currency on the blockchain (S506). For example, the apparatus 110 may record, through the blockchain network 140, information related to payment for the ticket on metadata of the NFT representing the ticket for which a trade has been executed. As such, the information related to the payment for the ticket corresponding to the NFT representing the ticket may be clearly managed.

In an embodiment, the information about the second account may include information about a payment method of the user for another service, and the apparatus 110 may determine approval of payment for the ticket through a fiat currency based on the information about the second account. Specifically, the apparatus 110 may acquire the information about the second account from the server 150 for the another service to acquire information about the payment method of the user for the another service. The information about the payment method of the user for the another service may refer to, in case that the another service includes a payment-related service, information about the payment method of the user for the corresponding payment-related service. For example, the payment-related service included in the another service may correspond to a service supporting payment using a simple method through the second account and may include a service that pre-registers the user's credit card or account information and enables easy payment through simple authentication such as biometric and password. For example, the payment-related service included in the another service may also be referred to as an easy payment service. The information about the payment method of the user for the another service may include information about a credit card or account information required for payment through the payment-related service included in the another service. That is, the apparatus 110 may store information about a credit card or account information required for payment through the payment-related service included in the another service and then use, in case of acquiring a request for ticket purchase through the fiat currency from the user terminal 120, the information to perform payment for the ticket and determine approval of payment for the ticket. Here, payment through the payment-related service included in the another service may be ticket payment through the fiat currency. For example, the apparatus 110 may use information about the corresponding credit card or account information to perform payment for the ticket through the external payment server 160 and determine approval of payment for the ticket. Accordingly, the user may perform payment for the ticket without inputting information about payment when requesting ticket purchase (depending on an embodiment, input of other additional authentication information may be required).

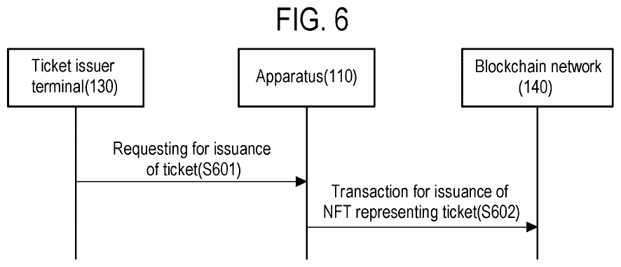

FIG. 6 is a sequence diagram illustrating a method according to an embodiment of the present disclosure. The ticket issuer terminal 130 may transmit a ticket issuance request to the apparatus 110 (S601). The ticket issuer may be a provider of a service corresponding to the ticket or an organizer of an event corresponding to the ticket. The ticket issuance request may include an initial price of the ticket, the number of tickets issued, details related to the service or event corresponding to the ticket, and the like.

The apparatus 110 may transmit a transaction for issuance of the NFT representing the ticket to the blockchain network 140 (S602). The apparatus 110 may transmit a transaction for issuance of the NFT representing the ticket to the blockchain network 140 at a first time point corresponding to a time point at which the ticket issuance request has been received from the ticket issuer terminal 130 so as to execute the smart contract. Accordingly, the NFT representing the ticket may be issued at the first time point. The NFT representing an initially issued ticket may be stored in the apparatus 110, that is, the digital asset wallet corresponding to the server or the digital asset wallet corresponding to the ticket issuer.

The NFT is issued at the first time point corresponding to the time point at which the ticket issuance request has been received from the ticket issuer terminal 130, and thereafter, when the ticket purchase request is acquired from the user terminal 120, the apparatus 110 may perform a transfer procedure with respect to the NFT representing the ticket already issued, without issuing an NFT representing the ticket.

In other words, in an embodiment, in response to the execution of the smart contract, the smart contract may transfer the NFT, which has been issued before the execution of the smart contract and represents the ticket, to the digital asset wallet (the first digital asset wallet or the second digital asset wallet) of the user. Specifically, the smart contract may transmit, to the digital asset wallet (the first digital asset wallet or the second digital asset wallet) of the user, the NFT representing the ticket, which has already been issued and is stored in the apparatus 110, that is, the digital asset wallet corresponding to the server or the digital asset wallet corresponding to the ticket issuer.

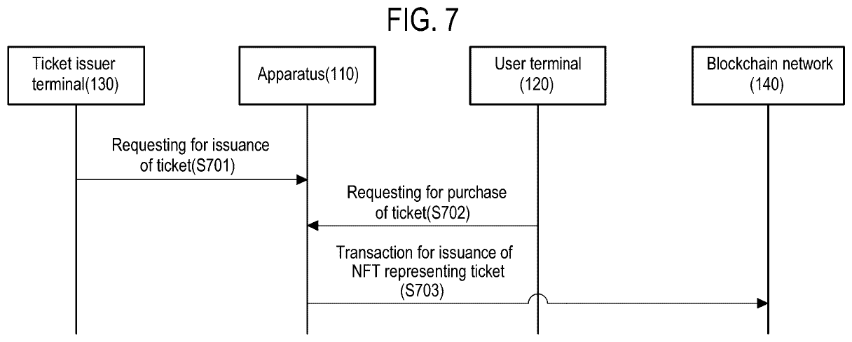

FIG. 7 is a sequence diagram illustrating a method according to an embodiment of the present disclosure. The ticket issuer terminal 130 may transmit a ticket issuance request to the apparatus 110 (S701). Here, the apparatus 110 may wait without performing an issuance procedure for the NFT representing the ticket at the first time point corresponding to the time point at which the ticket issuance request has been received from the ticket issuer terminal 130. Thereafter, in this state, the user terminal 120 may transmit a ticket purchase request to the apparatus 110 (S702). Thereafter, the apparatus 110 may transmit a transaction for issuance of the NFT representing the ticket to the blockchain network 140 (S703). That is, the apparatus 110 may transmit a transaction for issuance of the NFT representing the ticket to the blockchain network 140 at a second time point corresponding to a time point at which the ticket purchase request has been received from the user terminal 120 so as to execute the smart contract. Accordingly, the NFT representing the ticket may be issued at the second time point. The NFT representing the initially issued ticket may be stored in the apparatus 110, that is, the digital asset wallet corresponding to the server or the digital asset wallet corresponding to the ticket issuer, and immediately after being issued, may be transmitted to the digital asset wallet (the first digital asset wallet or the second digital asset wallet) of the user.

In other words, in an embodiment, in response to the execution of the smart contract, the smart contract may issue the NFT representing the ticket, and transfer the issued NFT to the digital asset wallet (the first digital asset wallet or the second digital asset wallet) of the user. Specifically, the smart contract may issue the NFT representing the ticket, store the NFT in the apparatus 110, that is, the digital asset wallet corresponding to the server or the digital asset wallet corresponding to the ticket issuer, and transmit the stored NFT representing the ticket to the digital asset wallet (the first digital asset wallet or the second digital asset wallet) of the user.

An aspect of the present disclosure may provide a platform configured to enable a trade of an NFT representing a ticket.

An aspect of the present disclosure may facilitate determination of the authenticity of a ticket.

An aspect of the present disclosure may prevent counterfeiting or fraudulent trades of a ticket.

The effects according to the technical idea of the present disclosure are not limited to the effects described above, and other effects not mentioned may be clearly understood by those skilled in the art from the description of the specification.

In the flowcharts of the present disclosure, each operation of the method is described in a sequential order, but each operation may be performed in an order that may be arbitrarily combined by the present disclosure, in addition to being performed sequentially. The description regarding the flowcharts of the present disclosure does not exclude changes or modifications to the method or algorithm, and does not imply that any operation is necessary or desirable. In an embodiment, at least some of the operations may be performed in parallel, iteratively or heuristically. In another embodiment, at least some of the operations may be omitted or other operations may be added.

Various embodiments according to the present disclosure may be implemented as software on a machine-readable storage medium. The software may be software for implementing various embodiments described in the present disclosure. The software may be inferred from the various embodiments described in the present disclosure by programmers in the technical field to which the present disclosure pertains. For example, the software may be a program that includes machine-readable instructions (e.g., instructions, code, or code segments). A machine is an apparatus that may operate according to commands retrieved from a storage medium, and may be, for example, a computer. In an embodiment, the machine may correspond to a computing apparatus according to various embodiments described in the present disclosure. In an embodiment, a processor of the apparatus may execute the retrieved command, causing components of the apparatus to perform a function corresponding to the command. The storage medium may refer to any type of recording medium on which data is stored and which may be read by an apparatus. The storage medium may include a ROM, a RAM, a CD-ROM, a magnetic tape, a floppy disk, optical data storage, and the like. In an embodiment, the storage medium may be implemented in a distributed form, such as in a computer system connected to a network. In this case, the software may be distributed on a computer system or the like and executed. In another embodiment, the storage medium may correspond to a non-transitory storage medium. The non-transitory medium refers to a tangible medium that exists regardless of whether data is stored semi-permanently or temporarily, and does not include a signal that is temporarily transmitted.

Although the technical concept according to the present disclosure has been described through various embodiments, the technical ideas of the present disclosure include various substitutions, modifications and changes that may be made within the scope understandable by those skilled in the art to which the present disclosure pertains. Further, such substitutions, modifications, and changes should be considered as being included within the scope of the claims.

What is claimed is:

1. A method performed in an apparatus including at least one processor and at least one memory in which instructions to be executed by the at least one processor are stored, the method being performed by the at least one processor and comprising:
acquiring a request for generating a first account for a non-fungible token (NFT)-related service from a terminal of a user, the request for generating the first account indicating another service distinguished from the NFT-related service;
acquiring information about a second account corresponding to an account of the user in the another service;
generating the first account of the user for the NFT-related service based on the information about the second account; and
generating a first digital asset wallet of the user and associating information about the first digital asset wallet with the first account of the user.

2. The method of claim 1, further comprising transmitting information about at least one of the first account or the first digital asset wallet to the terminal of the user.

3. The method of claim 2, further comprising causing the information about at least one of the first account or the first digital asset wallet to be displayed on the terminal of the user.

4. The method of claim 1, further comprising:
acquiring a wallet link request from the terminal of the user for associating a second digital asset wallet of the user with the first account; and
associating information about the second digital asset wallet with the first account of the user.

5. The method of claim 4, further comprising, in response to associating the information about the second digital asset wallet with the first account, causing the information about the first digital asset wallet not to be associated with the first account.

6. The method of claim 1, further comprising:
acquiring a request for ticket purchase through a fiat currency from the terminal of the user;
in response to the request for ticket purchase, determining approval of payment for a ticket through the fiat currency; and
transmitting an NFT representing the ticket to the first digital asset wallet of the user by executing a smart contract corresponding to the ticket through a blockchain network.

7. The method of claim 6, wherein the information about the second account includes information about a payment method of the user for the another service, and
wherein the determining approval of payment for the ticket includes determining approval of the payment for the ticket through the fiat currency based on the information about the second account.

8. The method of claim 6, further comprising recording, on a blockchain, information associated with payment for the ticket through the fiat currency through the blockchain network.

9. The method of claim 6, wherein the determining approval of payment for the ticket includes:
acquiring information indicating approval of payment for the ticket from an external payment server; and
determining approval of payment for the ticket through a fiat currency of the user based on the information indicating approval of payment for the ticket acquired from the external payment server.

10. The method of claim 1, further comprising, in case that the user corresponds to an owner of an NFT representing the ticket, providing information about the ticket to the terminal of the user.

11. The method of claim 1, wherein the generating the first account includes:
determining whether the user already owns an account for the NFT-related service; and
in response to the determination that the user does not already own an account for the NFT-related service, generating the first account of the user for the NFT-related service.

12. The method of claim 6, wherein in response to the execution of the smart contract, the smart contract is configured to issue the NFT representing the ticket and transfer the issued NFT to the first digital asset wallet of the user.

13. The method of claim 6, wherein in response to the execution of the smart contract, the smart contract is configured to transfer, to the first digital asset wallet of the user, the NFT which has been issued by the smart contract before the execution of the smart contract and represents the ticket.

14. The method of claim 6, wherein the smart contract is configured to:
based on at least one of a transferor, a transferee, or the NFT representing the ticket, determine whether the transferor permits transfer of the NFT representing the ticket from a digital asset wallet of the transferor to a digital asset wallet of the transferee; and
in response to the determination that the transfer is permitted, transfer the NFT representing the ticket from the digital asset wallet of the transferor to the digital asset wallet of the transferee.

15. An apparatus comprising:
a communication interface configured to communicate with a terminal of a user;
at least one processor; and
at least one memory in which instructions to be executed by the at least one processor are stored,
wherein the at least one processor is configured to, when the instructions are executed by the at least one processor:
acquire a request for generating a first account for an NFT-related service from the terminal of the user, the request for generating the first account indicating another service distinguished from the NFT-related service;
acquire information about a second account corresponding to an account of the user in the another service;
generate the first account of the user for the NFT-related service based on the information about the second account; and
generate a first digital asset wallet of the user and associate information about the first digital asset wallet with the first account of the user.

16. The apparatus of claim 15, wherein the at least one processor is configured to:
acquire a wallet link request from the terminal of the user for associating a second digital asset wallet of the user with the first account; and
associate information about the second digital asset wallet with the first account of the user.

17. The apparatus of claim 15, wherein the at least one processor is configured to:
acquire a request for ticket purchase through a fiat currency from the terminal of the user,
in response to the request for ticket purchase, determine approval of payment for a ticket through the fiat currency; and
transmit an NFT representing the ticket to the first digital asset wallet of the user by executing a smart contract corresponding to the ticket through a blockchain network.

18. The apparatus of claim 17, wherein the information about the second account includes information about a payment method of the user for the another service, and
wherein the at least one processor is configured to determine approval of payment for the ticket through the fiat currency based on the information about the second account.

19. The apparatus of claim 17, wherein the smart contract is configured to:
based on at least one of a transferor, a transferee, or the NFT representing the ticket, determine whether the transferor permits transfer of the NFT representing the ticket from a digital asset wallet of the transferor to a digital asset wallet of the transferee; and
in response to the determination that the transfer is permitted, transfer the NFT representing the ticket from the digital asset wallet of the transferor to the digital asset wallet of the transferee.

20. A non-transitory computer-readable recording medium configured to store instructions, when executed by at least one processor, causing the at least one processor to perform an operation,
wherein the instructions are configured to cause the at least one processor to:
acquire a request for generating a first account for an NFT-related service from a terminal of a user, the request for generating the first account indicating another service distinguished from the NFT-related service;
acquire information about a second account corresponding to an account of the user in the another service;
generate the first account of the user for the NFT-related service based on the information about the second account; and
generate a first digital asset wallet of the user and associating information about the first digital asset wallet with the first account of the user.
